(19) United States
(12) Patent Application Publication
(10) Pub. No.: US 2019/0366527 A1
(43) Pub. Date: Dec. 5, 2019

(54) DRIVING TOOL

(71) Applicant: MAKITA CORPORATION, Anjo-shi, Aichi (JP)

(72) Inventor: Yoshitaka AKIBA, Anjo-shi (JP)

(73) Assignee: MAKITA CORPORATION, Anjo-shi, Aichi (JP)

(21) Appl. No.: 16/480,301

(22) PCT Filed: Feb. 13, 2018
(86) PCT No.: PCT/JP2018/004846

§ 371 Date: Jul. 23, 2019

(30) Foreign Application Priority Data
Feb. 17, 2017 (JP) 2017-028517

(51) Int. Cl. B25C 1/06; B25C 7/00; B25C 5/15

(52) U.S. Cl. CPC B25C 1/06; B25C 5/15; B25C 7/00

(57) ABSTRACT

An electric driving tool includes a motor, a driver, a movable member, and a driver-restricting mechanism. The driver is configured to be driven by the motor and to strike and eject a fastener from an outlet by moving from a standby position to a striking position along a specified travel path. The movable member is disposed in a vicinity of the outlet and held in an initial position in a non-pressed state, and configured to be moved from the initial position to a pressed position when pressed by a workpiece. The driver-restricting mechanism is configured to prevent the driver from moving to the striking position when the movable member is placed in the initial position, and to allow the driver to move to the striking position when the movable member is placed in the pressed position.

### TECHNICAL FIELD

The present invention relates to a driving tool which is configured to eject a fastener from an outlet to drive the fastener into a workpiece

### BACKGROUND ART

A driving tool is known which is configured to eject a fastener such as a nail and drive the fastener into a workpiece by linearly moving a driver forward. In such a driving tool, the driver is returned rearward after ejecting the fastener. At this time, the driver may rebound forward by impact and eject a next fastener when such is not intended by a user. Therefore, for example, in U.S. Unexamined Patent Application Publication No. 2015/0096776, a driving tool is disclosed which is capable of restricting operation of a driver by using a bumper and a stopper. Specifically, in this driving tool, the driver is pressed from above by a pinch roller to abut on a flywheel, receives rotational energy of the flywheel and moves forward to eject a fastener.

Thereafter, the driver is returned rearward, rebounded forward by the bumper while being slightly deviated upward from a path for ejecting the fastener, and collides with a front stopper. The driver is then held in an initial position while being deviated from the path by a magnet disposed above the driver.

### SUMMARY OF THE INVENTION

### Problems to be Solved by the Invention

The above-described driving tool can prevent a fastener from being ejected due to rebound of the driver. However, if a control part actuates a pinch roller, for example, due to the influence of noise when such is not intended by a user, the driver is actuated to eject the fastener. Therefore, in the above-described driving tool, further improvement is desired in order to more reliably reduce the possibility that a fastener may be ejected when such is not intended by a user.

Accordingly, it is an object of the present invention to provide a technique for reducing the possibility that a fastener is ejected when such is not intended by a user, in a driving tool which is configured to drive a fastener into a workpiece with a driver.

### Embodiment to Solve the Problem

According to one aspect of the present invention, an electric driving tool is provided which is configured to eject a fastener from an outlet to drive the fastener into a workpiece. This driving tool includes a motor, a driver, a movable member and a driver-restricting mechanism.

The driver is configured to be driven by the motor and to strike and eject the fastener from the outlet by moving from a standby position to a striking position along a specified travel path, which extends in a front-rear direction of the driving tool. The striking position is located frontward of the standby position. The movable member is disposed in the vicinity of the outlet. The movable member is held in an initial position in a non-pressed state, and configured to be moved from the initial position to a pressed position when pressed by the workpiece. The driver-restricting mechanism is configured to prevent the driver from moving to the striking position when the movable member is placed in the initial position. Further, the driver-restricting mechanism is configured to allow the driver to move to the striking position when the movable member is placed in the pressed position.

When performing a driving operation by using the driving tool of the present aspect, a user can move the movable member from the initial position to the pressed position by pressing the movable member against the workpiece. In this case, the driver-restricting mechanism allows the driver to move to the striking position. Therefore, the driver can drive the fastener into the workpiece. On the other hand, in the non-pressed state in which the movable member is not pressed against the workpiece since a user has no intention to drive the fastener, the movable member is held in the initial position. Therefore, the driver-restricting mechanism prevents the driver from moving to the striking position. As described above, in the driving tool of the present aspect, unless a user presses the movable member against the workpiece with the intention of starting the driving operation and the movable member moves to the pressed position in response to the pressing, the driver cannot eject the fastener. Therefore, according to the present aspect, the possibility that the fastener may be ejected when such is not intended by a user can be reliably reduced.

It is noted that the fastener which can be used for the driving tool of the present aspect may include a nail, a rivet, a pin and a staple. The driving tool of the present aspect can also be referred to as, for example, a nailing machine, a tacker and a staple gun, according to the fastener to be used.

The driving tool of the present aspect may just be configured to move the driver from the standby position to the striking position using an electric motor serving as a driving source, and a driving system (driving mechanism) of the driver is not particularly limited. For example, a driving system of moving the driver by rotationally driving a flywheel by the motor and transmitting the rotational energy of the flywheel to the driver, and a driving system of moving the driver by the action of an air spring which is caused by reciprocally driving a piston within a cylinder by the motor can be suitably adopted.

The movable member may just be disposed in the vicinity of the outlet and configured to be movable between the initial position and the pressed position, and its structure is not particularly limited. Typically, the movable member may be disposed in the vicinity of the outlet so as to be movable in a front-rear direction of the driving tool and held in the initial position by forward biasing force of a biasing member.

The manner of the driver-restricting mechanism “preventing the driver from moving to the striking position” may include both the manner of preventing the driver from moving forward from the standby position (in other words, the manner of completely preventing the driver from moving forward) and the manner of preventing the driver from reaching the striking position while allowing the driver to move slightly forward from the standby position. The structure of preventing the driver from moving to the striking position is not particularly limited, but, for example, a structure of abutting on the driver on a travel path of the driver, a structure of immovably holding the driver in the initial position and a structure of preventing an actuator for starting movement of the driver from being started can be adopted.

According to one aspect of the present invention, the driver-restricting mechanism may be configured to prevent the driver from moving to the striking position by physically acting on the driver. In a structure of preventing movement of the driver by electrical control, a control part may malfunction, for example, due to noise. According to the present aspect, however, the structure configured to physically act on the driver can eliminate such a concern and can more reliably prevent the movement of the driver. Further, the manner of “physically acting” may typically mean the manner of “mechanically acting” or “acting via a mechanical lock member”.

According to one aspect of the present invention, the driver-restricting mechanism may include a blocking member which is configured to prevent the driver from moving to the striking position by abutting on a front end portion of the driver at a position rearward of the fastener. In other words, as an embodiment of a specific structure of physically acting on the driver, the blocking member which is configured to mechanically abut on the driver may be employed. According to the present aspect, the blocking member can reliably prevent the movement of the driver before the driver strikes the fastener.

According to one aspect of the present invention, the blocking member may be configured to be movable between a block position where the blocking member is capable of abutting on the driver on the travel path and a retracted position where the blocking member is retracted from the travel path and is incapable of abutting on the driver. The blocking member may be placed in the block position when the movable member is placed in the initial position. The movable member may be configured to move the blocking member from the block position to the retracted position when moving from the initial position to the pressed position. According to the present aspect, when the movable member is pressed and moved from the initial position to the pressed position, the blocking member can be automatically moved from the block position to the retracted position by the movable member. Therefore, a user can make the driver to be ready for driving a fastener simply by pressing the movable member against the workpiece. It is noted that the movable member may move the blocking member either by directly acting on the blocking member or via another member.

According to one aspect of the present invention, the driver-restricting mechanism may include a biasing member which biases the blocking member toward the block position. The movable member may be configured to move the blocking member from the block position to the retracted position against biasing force of the biasing member when moving from the initial position to the pressed position. The biasing member may be configured to return the blocking member to the block position by the biasing force along with movement of the movable member from the pressed position to the initial position. According to the present aspect, with the simple structure of the biasing member, the blocking member, which has been moved to the retracted position along with movement of the movable member to the pressed position, can be returned to the block position in interlock with movement of the movable member to the initial position. Therefore, a user need not perform an additional operation for returning the blocking member to the block position.

According to one aspect of the present invention, the blocking member may be formed as a rotary lever which is rotatable between the block position and the retracted position. The movable member may be configured to abut on the blocking member and turn the blocking member from the block position to the retracted position when moving from the initial position to the pressed position. According to the present aspect, the blocking member which moves from the block position to the retracted position in interlock with the movement of the movable member can be realized with a very simple structure.

According to one aspect of the present invention, the driving tool may further include a flywheel which is configured to be rotationally driven by the motor and to store rotational energy. The driver may be configured to move to the striking position by the rotational energy transmitted from the flywheel. The driver-restricting mechanism may be configured to prevent the driver from moving to the striking position before the rotational energy required to eject the fastener is transmitted to the driver. In a system in which the driver is driven by the flywheel, when relatively large rotational energy required to eject the fastener is transmitted to the driver, the driver moves toward the striking position at high speed. According to the present aspect, the driver-restricting mechanism can prevent movement of the driver before the driver starts moving at high speed, so that impact on the driver-restricting mechanism due to this prevention can be suppressed. It is noted that the movement of the driver need not necessarily be started by transmission of the rotational energy of the flywheel, and may be started by another actuator.

According to one aspect of the present invention, the driving tool may further include a flywheel and an actuating mechanism. The flywheel may be configured to be rotationally driven by the motor and to store rotational energy. The actuating mechanism may be configured to move the driver from the standby position to a transmitting position where the rotational energy can be transmitted from the flywheel to the driver. The driver may be configured to move to the striking position by the rotational energy which is transmitted from the flywheel in the transmitting position. The driver-restricting mechanism may be configured to prevent the driver from moving to the striking position by preventing actuation of the actuating mechanism when the movable member is placed in the initial position.

According to one aspect of the present invention, the driving tool may further include a flywheel, a ring member and a driver-moving mechanism. The flywheel may be configured to be rotationally driven around a first rotation axis by the motor. The ring member may be configured to transmit rotational energy of the flywheel to the driver. The driver-moving mechanism may be configured to move the driver relative to the ring member from the standby position to a transmitting position where the ring member is capable of transmitting the rotational energy to the driver. Further, the driver may be disposed to face an outer periphery of the flywheel in a radial direction of the flywheel. The ring member may be disposed to be loosely fitted onto the outer periphery of the flywheel when the driver is placed in the standby position. Further, the ring member may be configured to be frictionally engaged with the driver and the flywheel to be rotated by the flywheel around a second rotation axis different from the first rotation axis, thereby transmitting the rotational energy to the driver to push out the driver forward from the transmitting position, when the driver is moved to the transmitting position by the driver-moving mechanism. According to the present aspect, the driver may not be directly pressed against the flywheel rotating at high speed. Therefore, wear of the driver can be reliably suppressed. Thus, the durability of the driver can be enhanced. Further, although the ring member may need to be replaced when worn, the ring member may be inexpensive compared with the driver, so that the cost of spare parts can be reduced.

According to one aspect of the present invention, the blocking member may be configured to prevent movement of the driver by abutting on a front end portion of the driver before the driver moves to the transmitting position. According to the present aspect, impact on the blocking lever can be suppressed by preventing the movement of the driver while the driver is moving at relatively low speed.

### BRIEF DESCRIPTION OF THE DRAWINGS

FIG. 1 is an explanatory drawing showing the overall structure of a nailing machine, with a driver placed in a standby position.

FIG. 2 is an enlarged view of a body in FIG. 1.

FIG. 3 is a perspective view of the driver when viewed from above.

FIG. 4 is an explanatory drawing for illustrating the driver placed in a driving position.

FIG. 5 is an explanatory drawing for illustrating the driver placed in a striking position.

FIG. 6 is a perspective view showing a flywheel, a ring member, a holding mechanism and a pressing roller, with the driver placed in the standby position.

FIG. 7 is a sectional view taken along line VII-VII in FIG. 2.

FIG. 8 is an explanatory drawing showing a contact arm placed in an initial position and a blocking lever placed in a protruding position.

FIG. 9 is an explanatory drawing showing the contact arm placed in a pressed position and the blocking lever placed in a retracted position.

FIG. 10 is an explanatory drawing showing the driver placed in a transmitting position and a driver-driving mechanism.

FIG. 11 is a sectional view taken along line XI-XI in FIG. 10.

FIG. 12 is an explanatory drawing showing a state in which the blocking lever prevents movement of the driver when the contact arm is placed in the initial position.

### DESCRIPTION OF EMBODIMENT

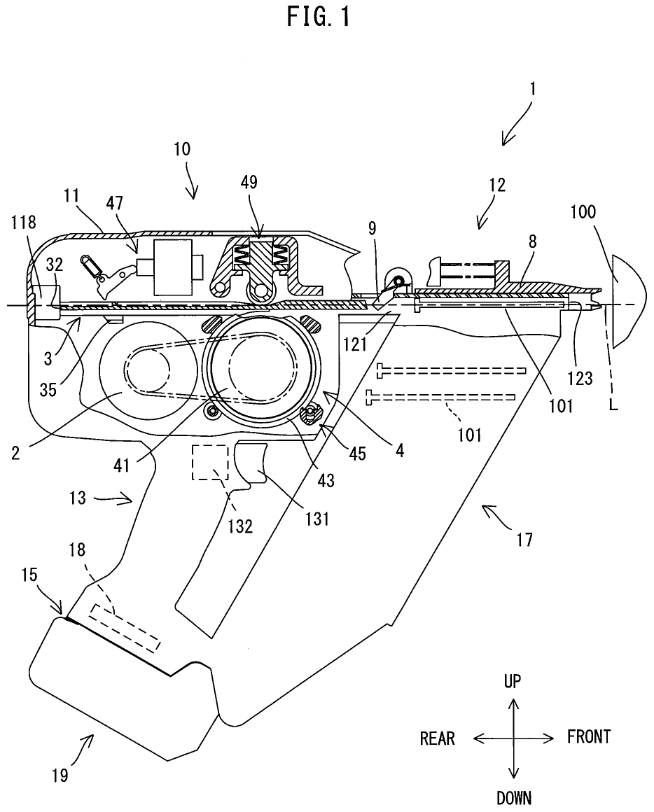

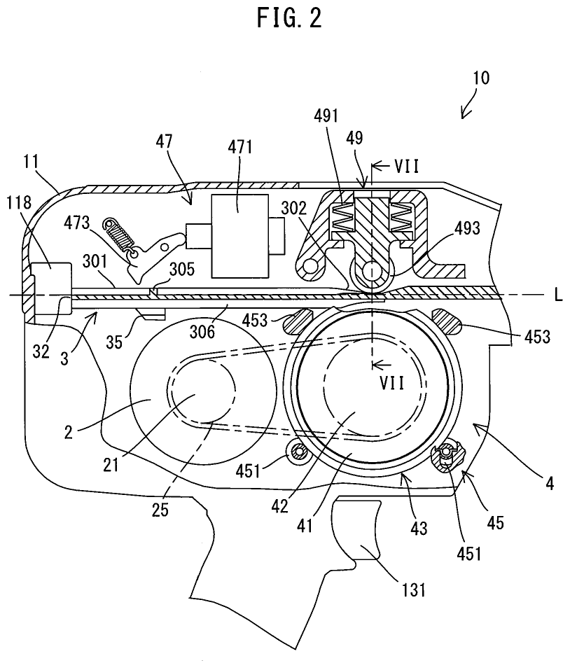

An embodiment of the present invention is now described with reference to the drawings. In the embodiment, an electric nailing machine 1 is described as an example of a driving tool. The nailing machine 1 is a tool which is capable of performing a nail-driving operation of driving a nail 101 into a workpiece 100 (such as wood) by linearly driving out the nail 101. It is noted that in FIGS. 1 and 2, for convenience of explanation, a ring member 43, which will be described later, is shown partially cutaway.

First, the general structure of the nailing machine 1 is described with reference to FIG. 1. As shown in FIG. 1, an outer shell of the nailing machine 1 is mainly formed by a body 10, a nose part 12, a handle 13 and a magazine 17.

The body 10 includes a body housing 11, a driver 3, a driver-driving mechanism 4 and a return mechanism (not shown). The body housing 11 forms an outer shell of the body 10 and houses a motor 2, the driver 3, the driver-driving mechanism 4 and the return mechanism (not shown). The driver 3 is configured to linearly move along a specified operation line L. The driver-driving mechanism 4 is configured to eject the nail 101 from the nailing machine 1 by moving the driver 3 along the operation line L by driving of the motor 2. The return mechanism is configured to return the driver 3 to an initial position after the nail 101 is ejected.

The nose part 12 is a portion which protrudes along the operation line L from one end of the body 10 in an extending direction of the operation line L (hereinafter simply referred to as an operation-line-L direction). It is noted that in FIG. 1, a portion of the nose part 12 is not shown. A passage 121 extends along the operation line L (in other words, on a travel path of the driver 3) inside the nose part 12. One end of the passage 121 communicates with an internal space of the body housing 11, and the other end is open to the outside of the nailing machine 1 and forms an outlet 123, through which the nail 101 is driven out. A contact arm 8 is held on a front end portion of the nose part 12 so as to be movable in a front-rear direction.

The handle 13 extends in a direction crossing the operation line L, from a central portion of the body housing 11 in the operation-line-L direction. The handle 13 is a portion to be held by a user. A trigger 131 to be pulled by a user is provided to a base end portion (an end portion connected to the body housing 11) of the handle 13. A battery mounting part 15 having terminals is provided on a leading end portion (an end portion opposite to the base end portion) of the handle 13. A rechargeable battery 19 can be removably mounted to the battery mounting part 15. Further, a trigger switch 132, which is connected to the trigger 131 and turned on in response to a pulling operation of the trigger 131, and a controller 18 for controlling the driver-driving mechanism 4 are disposed within the handle 13.

The magazine 17 is configured to be loaded with a plurality of nails 101 and mounted to the nose part 12. The nails 101 loaded in the magazine 17 may be fed one by one to a specified position within the passage 121 by a nail-feeding mechanism (not shown). A blocking lever 9, which serves to prevent movement of the driver 3, is disposed between the nail 101 which is placed within the passage 121 to be ejected and the driver 3. In the nailing machine 1 of the present embodiment, when the contact arm 8 is pressed against the workpiece 100 and moves, the prevention of movement of the driver 3 by the blocking lever 9 is released.

The detailed structure of the nailing machine 1 is now described. In the following description, for convenience sake, the operation-line-L direction of the driver 3 (right-left direction as viewed in FIG. 1) is defined as a front-rear direction of the nailing machine 1, and in the front-rear direction, the outlet 123 side (right side as viewed in FIG. 1) is defined as a front side of the nailing machine 1, while its opposite side (left side as viewed in FIG. 1) is defined as a rear side. Further, a direction (up-down direction as viewed in FIG. 1) which is orthogonal to the operation-line-L direction and which corresponds to the extending direction of the handle 13 is defined as an up-down direction of the nailing machine 1, and in the up-down direction, the side (upper side as viewed in FIG. 1) on which the handle 13 is connected to the body 10 (the body housing 11) is defined as an upper side, while the side (lower side as viewed in FIG. 1) of the leading end portion (on which the battery 19 may be mounted) of the handle 13 is defined as a lower side.

The motor 2, the driver 3 and the driver-driving mechanism 4 which are housed within the body housing 11 are first described in this order.

As shown in FIG. 2, the motor 2 serving as a driving source for the driver 3 is disposed within the body housing 11 such that a rotation axis of an output shaft (not shown) which rotates together with a rotor extends in a right-left direction, orthogonal to the operation line L. In the present embodiment, a compact and high-output brushless DC motor is employed as the motor 2. A pulley 21, which is configured to rotate together with the output shaft of the motor 2, is connected to the output shaft of the motor 2.

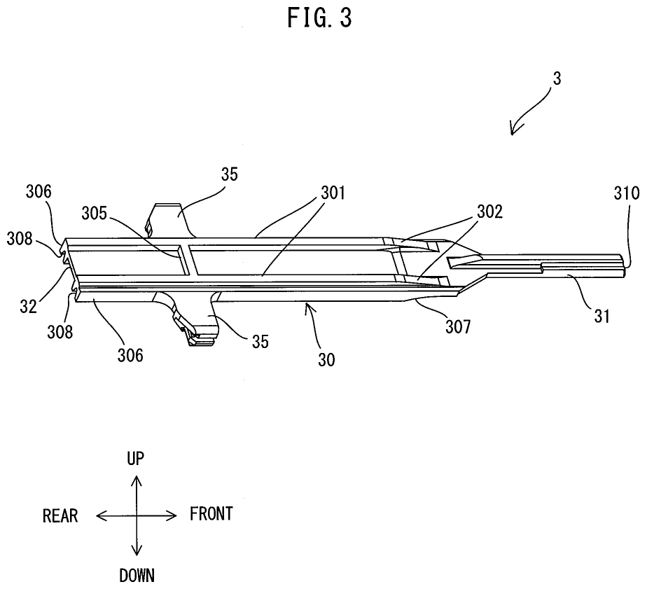

As shown in FIG. 3, the driver 3 is an elongate member, and formed to be symmetrical in the right-left direction relative to its longitudinal axis extending in the front-rear direction. The driver 3 includes a body 30 having a generally rectangular plate-like shape as a whole, a striking part 31 having a smaller width than the body 30 in the right-left direction and extending forward from a front end of the body 30, and a pair of arm parts 35 protruding to the right and left from a rear portion of the body 30.

The body 30 is a portion which is configured to be pressed by pressing rollers 493 (see FIG. 2), which will be described later, and to be frictionally engaged with the ring members 43 (see FIG. 2). The body 30 has a pair of roller-abutting parts 301, a lever-abutting part 305 and a pair of ring-engagement parts 306, which are described below in this order.

The pair of roller-abutting parts 301 are integrally formed with the body 30, protruding upward from an upper surface of the body 30 and extending in the front-rear direction along right and left edges of the body 30. A surface formed on a protruding end (upper end) of the roller-abutting part 301 is formed as an abutting surface to abut on an outer peripheral surface of the pressing roller 493. A front end portion of the roller-abutting part 301 is formed as an inclined part 302 which has a height (thickness in the up-down direction) gradually increasing toward the rear. On the other hand, a portion of the roller-abutting part 301 which extends rearward from the inclined part 302 has a constant height. The lever-abutting part 305 is formed to protrude upward from the upper surface of the body 30 and extends in the right-left direction so as to connect the right and left roller-abutting parts 301 in a rear portion of the body 30. The lever-abutting part 305 is a portion on which a push-out lever 473 to be described later may abut from the rear.

The pair of ring-engagement parts 306 are integrally formed with the body 30, protruding downward from a lower surface of the body 30 and extending in the front-rear direction along the right and left edges of the body 30. A front end portion of the ring-engagement part 306 is formed as an inclined part 307 which has a height (thickness in the up-down direction) gradually increasing toward the rear. The ring-engagement parts 306 have respective engagement grooves 308 configured to engage with respective outer peripheral engagement parts 431 of two ring members 43, which will be described later.

A rear end 32 of the body 30 defines a rear end of the driver 3. The rear end 32 is a portion which is configured to prevent the driver 3 from further moving rearward by abutting on a rear stopper part 118 (see FIG. 2) fixed within a rear end portion of the body housing 11. A front end 310 of the striking part 31 defines a front end of the driver 3. The front end 310 is a portion which is configured to strike a head of the nail 101 (see FIG. 1) to eject the nail 101 forward and drive the nail 101 into the workpiece 100.

The pair of arm parts 35 protrude to the left and right from the body 30. The arm parts 35 are portions which are configured to prevent the driver 3 from further moving forward by respectively abutting on a pair of front stopper parts (not shown) fixed within a front end portion of the body housing 11. Although not described in detail and shown, the arm parts 35 are each connected to the return mechanism by a connecting member. In the nailing machine 1 of the present embodiment, any known structure may be adopted as the return mechanism. For example, the return mechanism may be configured to return the driver 3, which has been moved forward, to the initial position by pulling the driver 3 along the operation line L, via the connecting members, by elastic force of compression coil springs.

The driver 3 having the above-described structure is disposed such that its longitudinal axis extends on the operation line L. Further, the driver 3 is held to be movable between a standby position and a driving position along the operation line L (in other words, in the front-rear direction of the nailing machine 1 or in the longitudinal direction of the driver 3).

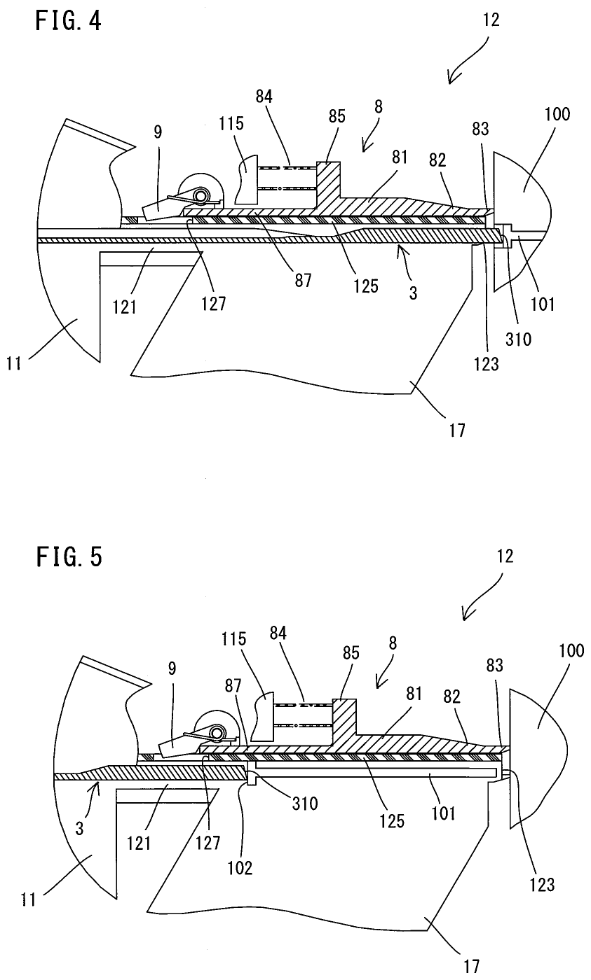

The standby position and the driving position of the driver 3 are now described with reference to FIGS. 1 and 4. The standby position is a position where the driver 3 is held in a state (hereinafter referred to as a standby state) that the driver-driving mechanism 4 is not actuated. In the present embodiment, as shown in FIG. 1, the standby position of the driver 3 is set to a position where the rear end 32 of the driver 3 abuts on the rear stopper part 118. The driving position is a position where the driver 3, which is moved forward by the driver-driving mechanism 4, drives the nail 101 into a workpiece. In the present embodiment, as shown in FIG. 4, the driving position of the driver 3 is set to a position where the front end 310 of the driver 3 slightly protrudes from the outlet 123. The driving position is also a position where front ends of the pair of arm parts 35 respectively abut on the pair of front stopper parts (not shown) from the rear. With the above-described arrangement, in the present embodiment, the standby position and the driving position can also be respectively referred to as a rearmost position and a foremost position which define opposite ends of a travel range of the driver 3 which moves along the operation line L.

Further, a striking position where the driver 3 actually strikes the nail 101 is located rearward of the driving position. As shown in FIG. 5, the striking position is a position where the front end 310 of the driver 3 abuts on a rear end 102 of the nail 101 placed in the specified position within the passage 121.

The structure of the driver-driving mechanism 4 is described in detail below. In the present embodiment, as shown in FIG. 2, the driver-driving mechanism 4 includes a flywheel 41, two ring members 43, a holding mechanism 45, an actuating mechanism 47 and a pressing mechanism 49. The structures of these components are now described in detail.

The flywheel 41 has a circular cylindrical shape and is rotatably supported in front of the motor 2 within the body housing 11 as shown in FIG. 2. A rotation axis of the flywheel 41 extends in parallel to a rotation axis of the motor 2 and in the right-left direction, orthogonal to the operation line L of the driver 3. A pulley 42 is connected to a support shaft (not shown) of the flywheel 41 and rotates together with the flywheel 41. A belt 25 is looped over the pulleys 21, 42. Rotation of the motor 2 is transmitted to the flywheel 41 via the pulleys 21, 42 and the belt 25, and the flywheel 41 rotates clockwise as viewed in FIG. 2.

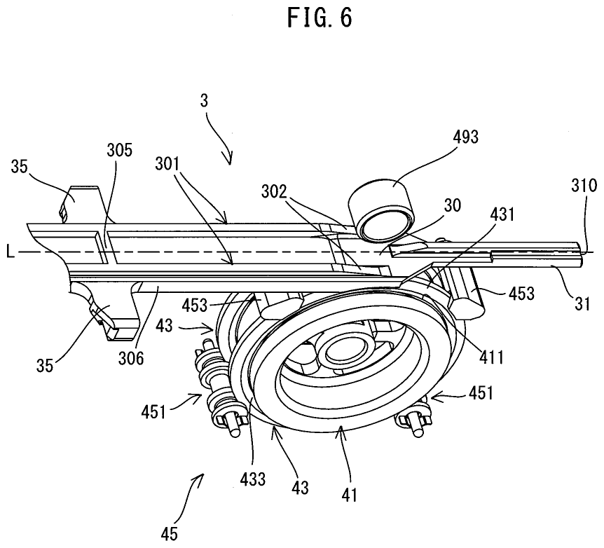

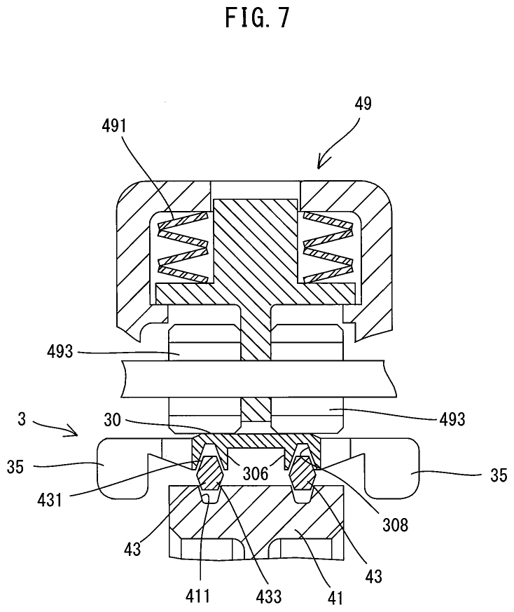

As shown in FIGS. 6 and 7, a pair of engagement grooves 411 are formed to extend over the whole circumference of the flywheel 41. The engagement grooves 411 are configured to engage with the ring members 43. Each of the engagement grooves 411 is formed such that its width in the right-left direction decreases toward the inner side in the radial direction.

As shown in FIG. 6, each of the ring members 43 has a ring-like shape having a larger diameter than the flywheel 41. In the present embodiment, the inner diameter of the ring member 43 is set to be larger than the outer diameter of the flywheel 41 (strictly, the diameter from the rotation axis of the flywheel 41 to the bottom of the engagement groove 411). The two ring members 43 are respectively disposed radially outside of the pair of engagement grooves 411 formed in an outer periphery of the flywheel 41. In the present embodiment, the two ring members 43 are each held by the holding mechanism 45, which will be described later, so as to be movable between a separate position where the ring member 43 is apart from the outer periphery (more specifically, the engagement groove 411) of the flywheel 41 and a contact position where the ring member 43 is in partial contact with the outer periphery (the engagement groove 411).

Each of the ring members 43 is a member for transmitting the rotational energy of the flywheel 41 to the driver 3, and configured to be frictionally engaged with the driver 3 and the flywheel 41. Specifically, as shown in FIG. 7, an outer peripheral engagement part 431 and an inner peripheral engagement part 433, which are respectively engageable with the engagement groove 308 of the driver 3 and the engagement groove 411 of the flywheel 41, are respectively formed in outer and inner peripheries of the ring member 43. The outer peripheral engagement part 431 is formed as a protrusion protruding outward in the radial direction of the ring member 43, and the inner peripheral engagement part 433 is formed as a protrusion protruding inward in the radial direction of the ring member 43. It is noted that the ring member 43 has a generally hexagonal cross-section in the radial direction, and the outer peripheral engagement part 431 is formed such that its thickness decreases toward the radially outer side of the ring member 43, and the inner peripheral engagement part 433 is formed such that its thickness in the axial direction decreases toward the radially inner side of the ring member 43. In other words, both the outer peripheral engagement part 431 and the inner peripheral engagement part 433 are formed to have a cross-section tapered toward their respective tip ends.

The holding mechanism 45 is configured to hold each of the ring members 43 so as to be movable between the separate position, in which the ring member 43 is apart from the outer periphery of the flywheel 41 (the engagement groove 411), and the contact position, in which the ring member 43 is in contact with the outer periphery (the engagement groove 411). As shown in FIGS. 2 and 6, the holding mechanism 45 of the present embodiment includes a pair of ring-biasing parts 451 and a pair of stoppers 453. The pair of ring-biasing parts 451 are respectively disposed diagonally forward and downward of the ring members 43 and diagonally rearward and downward of the ring members 43. The pair of ring-biasing parts 451 rotatably support the ring members 43 while biasing the ring members 43 upward from below by leaf springs. The pair of stoppers 453 are disposed below the driver 3 and respectively diagonally forward and upward of the ring members 43 and diagonally rearward and upward of the ring members 43. The stoppers 453 are configured to restrict upward movement of the ring members 43 while allowing rotation of the ring members 43.

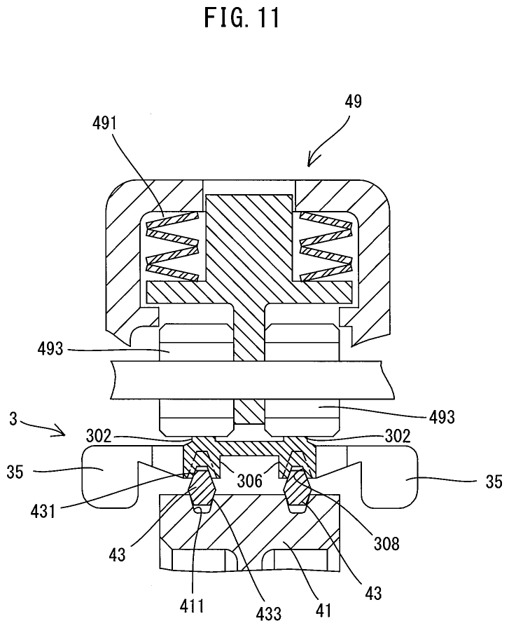

The manner of holding the ring members 43 by the holding mechanism 45 is now described. In the standby state, each of the ring-biasing parts 451 abuts on the ring members 43 from below to bias the ring members 43 upward, while each of the stoppers 453 abuts on the ring members 43 from above to prevent the ring members 43 from further moving upward. Thus, the ring members 43 are held in the separate position apart from the outer periphery (the engagement grooves 411) over the whole circumference of the flywheel 41 (see FIG. 7). On the other hand, as the driver 3 is moved forward by the driver-driving mechanism 4 and presses the ring members 43 downward, each of the ring members 43 is moved downward against the biasing force of the ring-biasing parts 451 and held in the contact position in contact with the outer periphery (the engagement grooves 411) on an upper portion of the flywheel 41 (see FIG. 11), which will be described in further detail later.

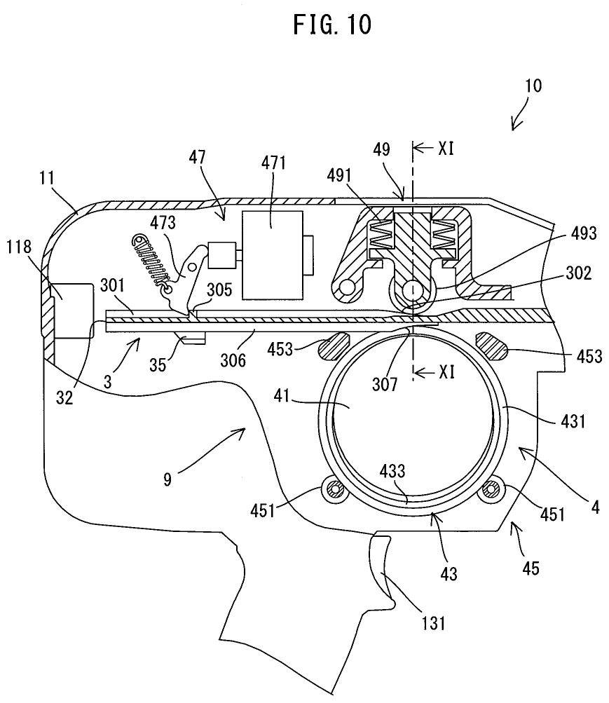

As shown in FIG. 2, the actuating mechanism 47 is disposed above the driver 3 and rearward of the flywheel 41 within the body housing 11. The actuating mechanism 47 is a mechanism which is configured to move the driver 3 placed in the standby position to a transmitting position described later. In the present embodiment, the actuating mechanism 47 mainly includes a solenoid 471 which is actuated by the controller 18 (see FIG. 1) when the trigger switch 132 (see FIG. 1) is switched on, and the push-out lever 473 which is turned by the solenoid 471. In the standby state, a leading end portion of the push-out lever 473 is held diagonally upward and rearward of the lever-abutting part 305 of the lever 3. When the solenoid 473 is actuated, the push-out lever 473 is turned and the leading end portion of the push-out lever 473 pushes the lever-abutting part 305 of the driver 3 forward from the rear and thereby moves the driver 3 forward (see FIG. 10).

As shown in FIG. 2, the pressing mechanism 49 is disposed above the flywheel 41 across the driver 3 within the body housing 11. The pressing mechanism 49 is configured to restrict movement of the driver 3 in a direction away from the flywheel 41 (that is, in the upward direction). Further, the pressing mechanism 49 is configured to press the driver 3 downward toward the ring members 43 in the process in which the driver 3 moves forward from the standby position. In the present embodiment, the pressing mechanism 49 includes a pair of pressing rollers 493 biased downward by disc springs 491. In the standby state, the pressing rollers 493 are held in a lowermost position while their downward movement is restricted.

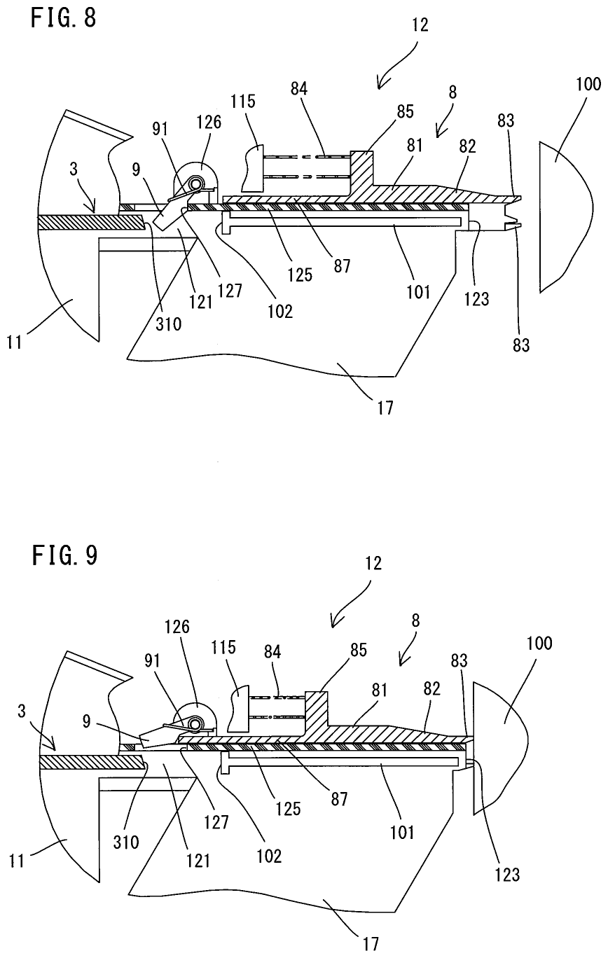

The structure of the nose part 12 is now described. As shown in FIG. 8, the nose part 12 includes a support member 125 which supports the contact arm 8 and the blocking lever 9. In the present embodiment, the support member 125 is formed of metal into a plate shape and disposed to extend in a generally horizontal direction and fixed to the body housing 11 by screws (not shown). A lower surface of the support member 125 defines an upper boundary of the passage 121 extending along the operation line L. Further, the support member 125 extends forward to the outlet 123.

The contact arm 8 is disposed in the vicinity of the outlet 123 and held in an initial position in a non-pressed state, and may be moved from the initial position to a pressed position when pressed by the workpiece 100. In the present embodiment, the contact arm 8 is supported by the support member 125 so as to be movable between the initial position and the pressed position in the operation-line-L direction (the front-rear direction). The contact arm 8 as a whole has an elongate shape extending in the front-rear direction, and includes a base part 81, a tip part 82, a spring-receiving part 85 and a lever-actuating part 87. It is noted that, in the present embodiment, the base part 81, the tip part 82, the spring-receiving part 85 and the lever-actuating part 87 are integrally formed of metal.

The base part 81 is formed into an elongate rod-like shape, and disposed on an upper surface of the support member 125 so as to extend in the front-rear direction. The tip part 82 is contiguous to a front end of the base part 81 and forms a front end portion of the contact arm 8. The tip part 82 has a C-shaped cross-section and arranged to surround a front end portion of the support member 125. The front end portion of the support member 125 is configured to slidably guide the tip part 82 in the front-rear direction. The spring-receiving part 85 is a portion which protrudes upward from a rear end portion of the base part 81. The lever-actuating part 87 is a portion which extends rearward from a rear end of the base part 81.

A body-side spring-receiving part 115 is provided behind the spring-receiving part 85 and fixed to the body housing 11. A biasing spring 84 is disposed between the body-side spring-receiving part 115 and the spring-receiving part 85 of the contact arm 8. In the present embodiment, a compression coil spring is employed as the biasing spring 84.

Here, the initial position and the pressed position of the contact arm 8 are described with reference to FIGS. 8 and 9.

In the non-pressed state in which the contact arm 8 is not pressed rearward, the contact arm 8 is placed in a foremost position within its movable range by the biasing force of the biasing spring 84. This position of the contact arm 8 is referred to as the initial position. As shown in FIG. 8, in the initial position, most of the tip part 82 of the contact arm 8 protrudes forward relative to the outlet 123. On the other hand, as shown in FIG. 9, when the tip part 82 is pressed against the workpiece 100, the contact arm 8 is moved rearward against the biasing force of the biasing spring 84. Although not shown in detail, in the present embodiment, a rearmost position of the contact arm 8 within the movable range is a position where the tip part 82 abuts on a portion of the support member 125 from the front and is thereby prevented from further moving rearward. This position of the contact arm 8 is referred to as the pressed position. In the pressed position, most of the tip part 82 of the contact arm 8 is overlapped on the support member 125 and only projections 83 formed on a tip end of the tip part 82 protrudes relative to the outlet 123.

The blocking lever 9 is configured to be movable between a block position where the blocking lever 9 protrudes into the passage 121, which is the travel path of the driver 3, and can abut on the driver 3, and a retracted position where the blocking lever 9 is retracted upward from the passage 121 and cannot abut on the driver 3, according to the position of the contact arm 8. In the present embodiment, the blocking lever 9 is configured as a metal rotary lever. The blocking lever 9 is rotatably supported by a pair of lever support parts 126 protruding upward from an upper surface of the support member 125. A rotation axis of the blocking lever 9 extends in the right-left direction, orthogonal to the operation line L. Further, the support member 125 has a through hole 127 which extends through the support member 125 in the up-down direction and which is formed slightly rearward of the rotation axis of the blocking lever 9 and just above the operation line L. The blocking lever 9 is biased downward (counterclockwise as viewed in FIG. 8) by a biasing spring 91. In the present embodiment, a torsion coil spring is employed as the biasing spring 91.

Here, the arrangement relationship between the contact arm 8 and the blocking lever 9 is described with reference to FIGS. 8 and 9.

As shown in FIG. 8, when the contact arm 8 is placed in the initial position, a rear end of the lever-actuating part 87 is located at a position forward of the through hole 127 and apart from the blocking lever 9 (in other words, in a position where it does not interfere with the blocking lever 9). Therefore, the blocking lever 9 is placed in the block position, protruding downward through the through hole 127 of the support member 125 by the biasing force of the biasing spring 91. At this time, the blocking lever 9 is located on the travel path of the driver 3, so that even if the driver 3 is moved forward, the blocking lever 9 abuts on the driver 3 and prevents further forward movement of the driver 3. It is noted that, in the block position, the blocking lever 9 abuts on the support member 125 at a front end of the through hole 127 and is thereby prevented from further turning.

As shown in FIG. 9, when the contact arm 8 is placed in the pressed position, the rear end of the lever-actuating part 87 moves rearward to the upper side of the through hole 127 and abuts on the blocking lever 9 and thereby turns the blocking lever 9 upward (clockwise as viewed in FIG. 9) against the biasing force of the biasing spring 91. Thus, the blocking lever 9 is held in the retracted position above the passage 121. In other words, the blocking lever 9 is not located on the travel path of the driver 3, so that the driver 3 is allowed to move forward within the passage 121 without being blocked by the blocking lever 9.

In the present embodiment, the block position is set such that the blocking lever 9 can abut on the driver 3 within the passage 121 after the driver 3 starts moving by being pushed by the push-out lever 473 (see FIG. 2) and before the driver 3 strikes the nail 101 (in other words, before the driver 3 reaches the striking position). Therefore, as shown in FIG. 8, it is configured such that a leading end portion of the blocking lever 9 placed in the block position is located between the front end 310 of the driver 3 placed in the standby position and the rear end 102 of the nail 101 placed within the passage 121.

Further, in the present embodiment, the contact arm 8 is connected to a contact arm switch, which is a well-known structure and therefore not shown. The contact arm switch is configured to be normally held in an off state and to be switched on when the contact arm 8 is moved to the pressed position. In the present embodiment, the controller 18 is configured to drive the motor 2 when the contact arm switch is switched on.

Operation of the nailing machine 1 having the above-described structure is now described.

As described above, in the standby state shown in FIG. 2, the driver 3 is placed in the standby position and each of the ring members 43 is held by the holding mechanism 45 in the separate position slightly apart from the outer periphery (more specifically, the engagement groove 411) of the flywheel 41 in a radially outward direction. Further, at this time, each of the pressing rollers 493 is held in the lowermost position and in sliding contact with the front end portion of the body 30 of the driver 3 from above, but not yet pressing the driver 3 downward. In this state, as shown in FIG. 7, each of the ring members 43 is held in a position where the outer peripheral engagement part 431 is slightly apart downward from the engagement groove 308 of the driver 3. Further, as shown in FIG. 8, the contact arm 8 is placed in the initial position, so that the blocking lever 9 protrudes into the passage 121 and is held in the block position. In other words, the blocking lever 9 is in a state in which it prevents the driver 3 from moving to the striking position.

When a user presses the contact arm 8 against the workpiece 100 with the intention of starting a driving operation, as shown in FIG. 9, the contact arm 8 turns and moves the blocking lever 9 upward to the retracted position while moving to the pressed position. Thus, the driver 3 is allowed to move to the striking position. Further, when the contact arm 8 is pressed to the pressed position, the contact arm switch (not shown) is switched on along with turning of the blocking lever 9. The controller 18 then starts driving of the motor 2. Thus, the flywheel 41 starts rotating. At this stage, however, the ring members 43 are each held in the separate position and are incapable of transmitting the rotational energy of the flywheel 41 to the driver 3. Therefore, even if the flywheel 41 rotates, the ring members 43 and the driver 3 do not operate.

Thereafter, when the user depresses the trigger 131 to switch the trigger switch 132 on, the controller 18 actuates the solenoid 471. Then, the push-out lever 473 turns and pushes the lever-abutting part 305 of the driver 3 forward from the rear. Thus, the driver 3 starts moving forward from the initial position toward the driving position along the operation line L. The driver 3 also moves relative to the ring members 43 each held in the separate position.

The pressing rollers 493 abut on the abutment surfaces of the inclined parts 302 from the front. As the inclined parts 302 move forward while being pressed by the pressing rollers 493, a portion of the outer peripheral engagement part 431 of each of the ring members 43 enters the engagement groove 308 of the driver 3 and abuts on an open end of the engagement groove 308. When the driver 3 further moves forward, the inclined parts 302 each function as a cam and further exhibits a wedge effect. Therefore, the ring members 43 are each pushed downward from the separate position against the biasing force of the ring-biasing parts 451. At the same time, the pressing rollers 493 are each pushed upward from the lowermost position against the biasing force of the disc springs 491.

When the driver 3 further moves forward and reaches the transmitting position shown in FIG. 10, as shown in FIG. 11, a portion of the inner peripheral engagement part 433 of each of the ring members 43 moved downward enters the engagement groove 411 of the flywheel 41 and abuts on an open end of the engagement groove 411, so that the ring member 43 is prevented from further moving downward. At this time, each of the ring members 43 is held in the contact position by the holding mechanism 45. The ring members 43 are each pressed against the flywheel 41 via the driver 3 by the elastic force of the disc springs 491 which are compressed when the pressing rollers 493 are pushed up by the inclined parts 302. Therefore, the portion of the outer peripheral engagement part 431 of the ring member 43 is frictionally engaged with the driver 3 at the open end of the engagement groove 308 of the driver 3, and the portion of the inner peripheral engagement part 433 of the ring member 43 is frictionally engaged with the flywheel 41 at the open end of the engagement groove 411 of the flywheel 41.

Thus, when the ring members 43 are frictionally engaged with the driver 3 and the flywheel 41, the ring members 43 become capable of transmitting to the driver 3 the rotational energy of the flywheel 41 which is required to eject the nail 101. Here, the “frictionally engaged” state refers to a state (including a sliding state) that the two members are engaged with each other by friction. Each of the ring members 43 is rotated by the flywheel 41 in a state in which only the portion of the inner peripheral engagement part 433 of the ring member 43 which is pressed against the flywheel 41 by the driver 3 is frictionally engaged with the flywheel 41. The rotation axis of the ring member 43 is different from the rotation axis of the flywheel 41. The driver 3, which is frictionally engaged with the ring members 43, is pushed out forward at high speed by the ring members 43.

When the pressing rollers 493 abut on the abutment surfaces of the rear portions of the inclined parts 302, the pressing rollers 493 are each pushed up to an uppermost position. Thus, the ring members 43 are further pressed against the flywheel 41 via the driver 3 by the elastic force of the disc springs 491. Therefore, frictional engagement between the driver 3 and the portion of the outer peripheral engagement part 431 and between the flywheel 41 and the portion of the inner peripheral engagement part 433 gets firmer. Thus, each of the ring members 43 can more efficiently transmit the rotational energy of the flywheel 41 to the driver 3.

The driver 3 reaches the striking position shown in FIG. 5 to strike the nail 101, and further moves to the driving position shown in FIG. 4 to drive the nail 101 into the workpiece 100. Movement of the driver 3 is stopped when the front ends of the arm parts 35 of the driver 3 abut on the front stopper parts (not shown) from the rear. When a specified time required for the driver 3 to reach the striking position elapses after the trigger switch 132 is switched on, the controller 18 stops supply of current to the solenoid 471 to thereby return the push-out lever 473 to the initial position. In this state, when the user releases pressing of the contact arm 8 against the workpiece 100 and the contact arm switch (not shown) is switched off, the controller 18 stops driving of the motor 2. Then, the flywheel 41 stops rotating and the return mechanism (not shown) is actuated to return the driver 3 to the standby position.

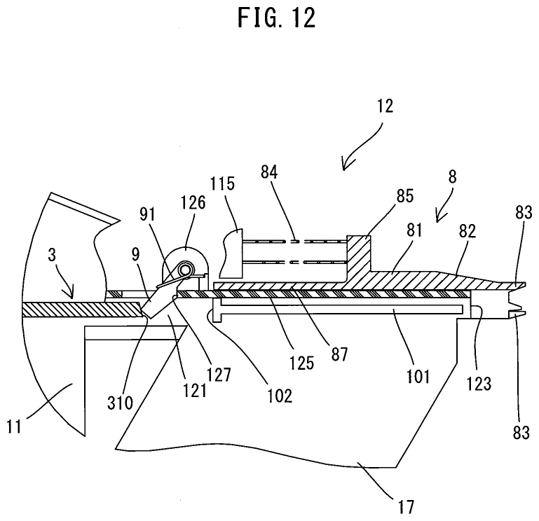

When the controller 18 properly operates, the nailing machine 1 operates as described above. On the other hand, if the controller 18 malfunctions, for example, due to the influence of noise, to start driving of the motor 2 and actuate the solenoid 471 even if the contact arm 8 is not placed in the pressed position, the driver 3 is moved forward from the standby position. In such a case, in the present embodiment, the blocking lever 9 prevents the driver 3 from moving to the striking position. Specifically, the blocking lever 9 is held in the block position on the travel path of the driver 3, unless the contact arm 8 is moved to the pressed position. Therefore, as shown in FIG. 12, even if the driver 3 is moved forward, the blocking lever 9 abuts on the front end 310 of the driver 3 from the front, thereby reliably preventing the driver 3 from reaching the striking position. In the block position, as described above, the blocking lever 9 abuts on the support member 125 at the front end of the through hole 127, so that even if the driver 3 collides with the blocking lever 9 from the rear, the blocking lever 9 is prevented from further turning forward and can reliably block the driver 3.

It is preferred that the blocking lever 9 prevents further movement of the driver 3 by abutting on the driver 3 before the rotational energy of the flywheel 41 which is required to eject the nail 101 is fully transmitted to the driver 3 which has started moving by being pushed by the push-out lever 473. This is because impact on the blocking lever 9 can be suppressed by preventing movement of the driver 3 while the driver 3 is moving at relatively low speed. From this viewpoint, it is preferred that the distance between the front end 310 of the driver 3 located in the standby position and the blocking lever 9 placed in the block position in the front-rear direction (see FIG. 8) is shorter than the distance of travel of the driver 3 from the standby position to the transmitting position.

As described above, according to the nailing machine 1 of the present embodiment, unless a user presses the contact arm 8 against the workpiece 100 to move the contact arm 8 to the pressed position with the intention of starting a driving operation, the blocking lever 9 prevents the driver 3 from moving to the striking position, so that the driver 3 cannot eject the nail 101. Therefore, the possibility that the nail 101 may be ejected when such is not intended by a user can be reliably reduced.

Particularly, the blocking lever 9 physically acts (specifically, abuts) on the driver 3 to prevent the driver 3 from moving to the striking position. In a structure of preventing movement of the driver 3 by electrical control, a control part may malfunction, for example, due to noise. The blocking lever 9, however, can eliminate such a concern and can more reliably prevent movement of the driver 3. Further, the block position is set rearward of the nail 101 placed in the passage 121, so that the blocking lever 9 can reliably prevent movement of the driver 3 before the driver 3 strikes the nail 101.

Further, when the contact arm 8 is placed in the initial position in the non-pressed state, the blocking lever 9 is held in the block position where the blocking lever 9 can abut on the driver 3 on the travel path of the driver 3 (within the passage 121). Then, when moving from the initial position to the pressed position, the contact arm 8 moves the blocking lever 9 to the retracted position where the blocking lever 9 cannot abut on the driver 3. Therefore, the user can make the driver 3 to be ready for ejecting the nail 101 simply by pressing the contact arm 8 against the workpiece 100. Further, the blocking lever 9 is biased toward the block position by the biasing spring 91, so that the user can return the blocking lever 9 to the block position simply by releasing pressing of the contact arm 8 to return the contact arm 8 to the initial position. Thus, the user need not perform an additional operation to return the blocking lever 9 to the block position.

Correspondences between the features of the embodiment and the features of the invention are as follows. The nailing machine 1 is an example that corresponds to the “driving tool” according to the present invention. The outlet 123 is an example that corresponds to the “outlet” according to the present invention. The nail 101 is an example that corresponds to the “fastener” according to the present invention. The motor 2 is an example that corresponds to the “motor” according to the present invention. The driver 3 is an example that corresponds to the “driver” according to the present invention. The contact arm 8 is an example that corresponds to the “movable member” according to the present invention. The blocking lever 9 is an example that corresponds to each of the “driver-restricting mechanism”, the “driver-restricting mechanism configured to physically act on the driver” and the “blocking member configured to abut on the front end portion of the driver” according to the present invention. The biasing spring 91 is an example that corresponds to the “biasing member” according to the present invention. The flywheel 41 is an example that corresponds to the “flywheel” according to the present invention.

The above-described embodiment is merely an example, and a driving tool according to the present invention is not limited to the structure of the nailing machine 1 of the above-described embodiment. For example, the following modifications or changes may be made. Further, one or more of these modifications or changes may be applied in combination with the nailing machine 1 of the above-described embodiment or the claimed invention.

The driving tool may be a driving tool for driving out a fastener other than the nail 101. For example, the driving tool may be embodied as a tacker or a staple gun for driving out a rivet, a pin or a staple. Further, the driving source of the flywheel 41 is not particularly limited to the motor 2. For example, an AC motor may be employed in place of the brushless DC motor.

The shape of the driver 3 and the structure of the driving mechanism which is configured to drive the driver 3 using the motor 2 as the driving source may be appropriately changed. For example, the driver-driving mechanism 4 of the above-described embodiment is configured such that the rotational energy of the flywheel 41 which is rotationally driven by the motor 2 is transmitted to the driver 3 by the ring members 43. In the case of such a structure, engagement of the ring members 43 with the driver 3 and the flywheel 41 is not limited to the engagement exemplified in the above-described embodiment. For example, the number of the ring members 43 and the numbers of the engagement grooves 308 of the driver 3 and the engagement grooves 411 of the flywheel 41 which correspond to the ring members 43 may be one, or three or more. Further, for example, the shapes, arrangements, numbers and engaging positions of the outer peripheral engagement part 431 and the inner peripheral engagement part 433 and the corresponding engagement grooves 308 and 411 may be appropriately changed.

In place of the driver-driving mechanism 4, a driving mechanism may be adopted which is configured to frictionally engage the driver 3 with the flywheel 41 to thereby directly transmit the rotational energy of the flywheel 41 to the driver 3 without using the ring members 43. Alternatively, another driving mechanism may be adopted which is configured to reciprocally drive a piston within a cylinder by the motor 2 to move the driver 3 by the action of an air spring.

The shape of the contact arm 8 and the manner of holding the contact arm 8 can be appropriately changed. Further, the structure of preventing or allowing movement of the driver 3 to the striking position by moving between the block position and the retracted position along with movement of the contact arm 8 is not limited to the blocking lever 9. For example, in place of the rotary lever, a mechanism may be adopted which includes a blocking member configured to be retractable in the up-down direction from the passage 121 through the through hole 127. Further, in the above-described embodiment, the contact arm 8 is configured to move the blocking lever 9 to the retracted position by abutting on the blocking lever 9, but the contact arm 8 may be configured to move a member which abuts on the driver 3 via another intervening member.

In the above-described embodiment, the blocking lever 9 blocks movement of the driver 3 after the driver 3 starts moving at low speed by being pushed by the push-out lever 473 and before the driver 3 reaches the striking position, but the blocking lever 9 may be configured to prevent the driver 3 from moving from the standby position. Specifically, the blocking lever 9 may be configured to prevent movement of the driver 3 by abutting on the front end 310 of the driver 3 located in the standby position when the contact arm 8 is placed in the initial position. Alternatively, for example, a mechanism may be provided and configured to prevent the driver 3 from being pushed (specifically from starting moving) by abutting on the push-out lever 473 from the front when the contact arm 8 is placed in the initial position, while allowing the driver 3 to be pushed by moving apart from the push-out lever 473 when the contact arm 8 is placed in the pressed position.

Further, in view of the nature of the present invention and the above-described embodiment, the following structures (aspects) are provided. One or more of the following structures may be employed in combination with the nailing machine 1 of the above-described embodiment or the claimed invention.

### (Aspect 1)

The blocking member may be formed as a rotary lever which is rotatable between the block position and the retracted position, and

the movable member may be configured to abut on the blocking member and turn the blocking member from the block position to the retracted position when moving from the initial position to the pressed position.

According to the present aspect, the blocking member which moves from the block position to the retracted position in interlock with movement of the movable member can be realized with a very simple structure.

### (Aspect 2)

The driving tool may comprise:

a flywheel that is rotationally driven around a first rotation axis by the motor,

a ring member that is configured to transmit rotational energy of the flywheel to the driver, and

a driver-moving mechanism that is configured to move the driver relative to the ring member from the standby position to a transmitting position where the ring member is capable of transmitting the rotational energy to the driver, wherein:

the driver is disposed to face an outer periphery of the flywheel in a radial direction of the flywheel,

the ring member is disposed to be loosely fitted onto the outer periphery when the driver is placed in the standby position, and

the ring member is configured to be frictionally engaged with the driver and the flywheel and rotated by the flywheel around a second rotation axis different from the first rotation axis, thereby transmitting the rotational energy to the driver to push out the driver forward from the transmitting position, when the driver is moved to the transmitting position by the driver-moving mechanism.

According to the present aspect, the driver can be prevented form being directly pressed against the flywheel rotating at high speed. Therefore, wear of the driver can be reliably suppressed. Thus, the durability of the driver can be enhanced. Further, although the ring member needs to be replaced when worn, the ring member may be inexpensive compared with the driver, so that the cost of spare parts can be reduced.

### (Aspect 3)

In the driving tool as defined in Aspect 2,

the blocking member may be configured to prevent movement of the driver by abutting on a front end portion of the driver before the driver moves to the transmitting position.

According to the present aspect, impact on the blocking lever can be suppressed by preventing movement of the driver while the driver is moving at relatively low speed.

### DESCRIPTION OF NUMERALS

1: nailing machine, 10: body, 11: body housing, 115: body-side spring-receiving part, 118: rear stopper, 12: nose part, 121: passage, 123: outlet, 125: support member, 126: lever support part, 127: through hole, 13: handle, 131: trigger, 132: trigger switch, 15: battery mounting part, 17: magazine, 18: controller, 19: battery, 2: motor, 21: pulley, 25: belt, 3: driver, 30: body, 301: roller-abutting part, 302: inclined part, 305: lever-abutting part, 306: ring-engagement part, 307: inclined part, 308: engagement groove, 31: striking part, 310: front end, 32: rear end, 35: arm part, 4: driver-driving mechanism, 41: flywheel, 411: engagement groove, 42: pulley, 43: ring member, 431: outer peripheral engagement part, 433: inner peripheral engagement part, 45: holding mechanism, 451: ring-biasing part, 453: stopper, 47: actuating mechanism, 471: solenoid, 473: push-out lever, 49: pressing mechanism, 491: disc spring, 493: pressing roller, 8: contact arm, 81: base part, 82: tip part, 83: projection, 84: biasing spring, 85: spring-receiving part, 87: lever-actuating part, 9: blocking lever, 91: biasing spring, 100: workpiece, 101: nail, 102: rear end, L: operation line

1. An electric driving tool configured to eject a fastener from an outlet to drive the fastener into a workpiece, the driving tool comprising:
a motor;
a driver configured to be driven by the motor and to strike and eject the fastener from the outlet by moving from a standby position to a striking position along a specified travel path, the travel path extending in a front-rear direction of the driving tool, the striking position being located frontward of the standby position;
a movable member disposed in a vicinity of the outlet, the movable member being held in an initial position in a non-pressed state and configured to be moved from the initial position to a pressed position when pressed by the workpiece; and
a driver-restricting mechanism configured to prevent the driver from moving to the striking position when the movable member is placed in the initial position, and to allow the driver to move to the striking position when the movable member is placed in the pressed position.

2. The driving tool as defined in claim 1, wherein the driver-restricting mechanism is configured to prevent the driver from moving to the striking position by physically acting on the driver.

3. The driving tool as defined in claim 1, wherein the driver-restricting mechanism includes a blocking member configured to prevent the driver from moving to the striking position by abutting on a front end portion of the driver at a position rearward of the fastener.

4. The driving tool as defined in claim 3, wherein:
the blocking member is configured to be movable between a block position where the blocking member is capable of abutting on the driver on the travel path and a retracted position where the blocking member is retracted from the travel path and is incapable of abutting on the driver, and the blocking member is placed in the block position when the movable member is placed in the initial position, and
the movable member is configured to move the blocking member from the block position to the retracted position when moving from the initial position to the pressed position.

5. The driving tool as defined in claim 4, wherein:
the driver-restricting mechanism includes a biasing member which biases the blocking member toward the block position,
the movable member is configured to move the blocking member from the block position to the retracted position against biasing force of the biasing member when moving from the initial position to the pressed position, and
the biasing member is configured to return the blocking member to the block position by the biasing force along with movement of the movable member from the pressed position to the initial position.

6. The driving tool as defined in claim 4, wherein:
the blocking member is formed as a rotary lever which is rotatable between the block position and the retracted position, and
the movable member is configured to abut on the blocking member and turn the blocking member from the block position to the retracted position when moving from the initial position to the pressed position.

7. The driving tool as defined in claim 1, further comprising:
a flywheel configured to be rotationally driven by the motor and to store rotational energy, wherein:
the driver is configured to move to the striking position by the rotational energy transmitted from the flywheel, and
the driver-restricting mechanism is configured to prevent the driver from moving to the striking position before the rotational energy required to eject the fastener is transmitted to the driver.

8. The driving tool as defined in claim 1, further comprising:
a flywheel configured to be rotationally driven by the motor and to store rotational energy; and
an actuating mechanism configured to move the driver from the standby position to a transmitting position where the rotational energy can be transmitted from the flywheel to the driver, wherein:
the driver is configured to move to the striking position by the rotational energy transmitted from the flywheel in the transmitting position, and
the driver-restricting mechanism is configured to prevent the driver from moving to the striking position by preventing actuation of the actuating mechanism when the movable member is placed in the initial position.

9. The driving tool as defined in claim 1, comprising:
a flywheel configured to be rotationally driven around a first rotation axis by the motor;
a ring member configured to transmit rotational energy of the flywheel to the driver; and
a driver-moving mechanism configured to move the driver relative to the ring member from the standby position to a transmitting position where the ring member is capable of transmitting the rotational energy to the driver, wherein:
the driver is disposed to face an outer periphery of the flywheel in a radial direction of the flywheel,
the ring member is disposed to be loosely fitted onto the outer periphery when the driver is placed in the standby position, and
the ring member is configured to be frictionally engaged with the driver and the flywheel to be rotated by the flywheel around a second rotation axis different from the first rotation axis, thereby transmitting the rotational energy to the driver to push out the driver forward from the transmitting position, when the driver is moved to the transmitting position by the driver-moving mechanism.

10. The driving tool as defined in claim 9, wherein the driver-restricting mechanism includes a blocking member configured to prevent movement of the driver by abutting on a front end portion of the driver before the driver moves to the transmitting position.
